(19) United States
(12) Patent Application Publication
(10) Pub. No.: US 2011/0229067 A1
(43) Pub. Date: Sep. 22, 2011

(54) BEARING CAGES WITH HIGH SPEED FEATURES

(75) Inventors: James BROWN, ROCK HILL, SC (US); Charles SCHWAB, FORT MILL, SC (US); Joseph GRIFFIN, MATHEWS, NC (US); Seth CLAUS, CHARLOTTE, NC (US)

(73) Assignee: Schaeffler Technologies GmbH & Co. KG, Herzogenaurach (DE)

(21) Appl. No.: 12/728,800

(22) Filed: Mar. 22, 2010

(51) Int. Cl. F16C 33/48; F16C 33/46

(52) U.S. Cl. 384/572; 384/623

(57) ABSTRACT

The bearing cage with high speed features has a pocket with a first flange and a second flange which defines the outer boundaries of the pocket. The first flange and the second flange each have a plurality of inwardly directed protrusions facing each other. The protrusions are contactable at each end of rollers, which are arranged in the bearing cage. The protrusions can be dome shaped, creating a small area of contact between the rollers and protrusions. The point of contact between the rollers and the protrusions is at the center of the rollers, which reduces the relative speed between the ends of the pockets and the rollers.

### FIELD OF INVENTION

The present invention relates to bearing cages and more particularly to the reduction of both the contact areas and the relative speed between the ends of rollers and the inside of the ends of the cage pocket.

### BACKGROUND OF THE INVENTION

Bearing cages are typically used in industrial equipment and automobile transmissions. Currently, a “domed end” (NRA) style roller is used for reducing the contact between the roller ends and the inside of the ends of the cage pockets. NRA style rollers also aid in reducing or eliminating high sliding contact areas of bearing cages. Achieving domed ends on an NRA style roller requires an extra tumbling procedure and more grinding passes than the standard procedure used to manufacture rollers in order to remove excess material from the outside diameter. Thus, manufacturing domed end NRA style rollers significantly increases overall production time and cost.

### SUMMARY OF THE INVENTION

The present invention is directed to a bearing cage, which has a special feature that reduces both the contact areas and the relative speed between the ends of the rollers and the inside of the ends of the cage pockets by using domed shaped protrusions in the cage flanges. The cage flanges can include and are not limited to a variety of configurations. The protrusions are the only parts of the cage that contact the ends of the roller. The area of contact is small due to the domed shape of the protrusions and the point of contact is in the center of the roller, thus reducing relative speed between the ends of the pockets and the spinning rollers. The rollers can either be standard end roller (NRB) or a domed end roller (NRA).

The design of the present invention can be used in thrust bearing cages and radial bearing cages. Radial bearing cages, which have the special feature of the present invention, may be used as a cage-and-roller assembly or may be encapsulated within a drawn cup or machined race. Thrust bearing cages utilizing the present invention may also be used as a cage-and-roller assembly or they may be encapsulated within sheet metal races or precision ground races.

The present invention is particularly useful in high speed applications. Moreover, the protrusions of the present invention will help retain needle rollers in their respective cage pockets, especially in cases where the rollers have a tendency to tilt out of the pockets.

Broadly, the present invention can be defined as a bearing cage with high speed features, comprising a pocket, which has a first flange and a second flange that define the outer boundaries of the pocket. The first flange and the second flange each have a plurality of inwardly directed protrusions facing each other.

In an additional embodiment, rollers are arranged in the cage.

In a further embodiment, the protrusions are contactable with the rollers.

In yet a further embodiment, the protrusions and rollers are contactable at a center of ends of the rollers.

In yet a further embodiment, the protrusions are dome shaped.

In another embodiment, the bearing cage is a radial hearing cage.

In another embodiment, the bearing cage is a thrust bearing cage.

### BRIEF DESCRIPTION OF THE DRAWINGS

The present invention will be further understood and appreciated by reading the following description in conjunction with the accompanying drawings, in which:

FIG. 1 is a cross-sectional view illustrating an existing radial cage with a domed shaped roller;

FIG. 2 is an alternative cross-sectional view illustrating an existing axial cage with a domed shaped roller;

FIG. 3 is a cross-sectional view illustrating an existing standard “M” cage with a roller;

FIG. 4 is an end view illustrating an existing standard “M” cage showing the area of the cage where the roller contacts the pocket end;

FIG. 5 is a cross-sectional view illustrating an existing standard “W” or “U” cage with a roller;

FIG. 6 is an end view illustrating an existing standard “W” or “U” cage showing the area of the cage where the roller contacts the pocket end;

FIG. 7 is a cross-sectional view illustrating an existing standard sigma style cage with a roller;

FIG. 8 is an end view illustrating an existing standard sigma cage showing the area of the cage where the roller contacts the pocket end;

FIG. 9 is a cross-sectional view illustrating a special sigma style cage with a roller;

FIG. 10 is an end view illustrating the special sigma style cage showing the area of the cage where the roller contacts the pocket end;

FIG. 11 is a top view of a cage with protrusions and rollers positioned in a radial cage between the protrusions;

FIG. 12 is a cross-sectional view of the radial bearing cages with special features showing the small area of contact between the center of the roller ends and the protrusions;

FIG. 13 is a cross-sectional view of the radial bearing cages with special features showing the protrusions contacting a roller;

FIG. 14 is an inverted cross-sectional view of the radial bearing cages with special features showing the protrusions contacting a roller;

FIG. 15 is a top view of a cage with protrusions and rollers positioned in a thrust cage between the protrusions;

FIG. 16 is a cross-sectional view of the thrust bearing cages with special features showing the protrusions contacting a roller;

FIG. 17 is an end view of the cross-sectional view of FIG. 16, showing the small area of contact in the center of the roller ends between the thrust cage and roller;

FIG. 18 is a first cross-sectional view showing a first potential flange configuration;

FIG. 19 is a first cross-sectional view showing a second potential flange configuration;

FIG. 20 is a first cross-sectional view showing a third potential flange configuration;

FIG. 21 is a first cross-sectional view showing a fourth potential flange configuration;

FIG. 22 is a first cross-sectional view showing a fifth potential flange configuration;

FIG. 23 is a first cross-sectional view showing a sixth potential flange configuration;

FIG. 24 is a first cross-sectional view showing a seventh potential flange configuration;

FIG. 25 is a first cross-sectional view showing a eighth potential flange configuration; and

FIG. 26 is a first cross-sectional view showing a ninth potential flange configuration.

### DETAILED DESCRIPTION OF THE INVENTION

Referring now to the drawings, in which like reference numerals refer to like reference parts throughout, FIG. 1 shows a cross-sectional view of a known radial cage 10 with a domed end (NRA) style roller 12 used to reduce contact between the roller ends 14, 16 and the cage pocket 18.

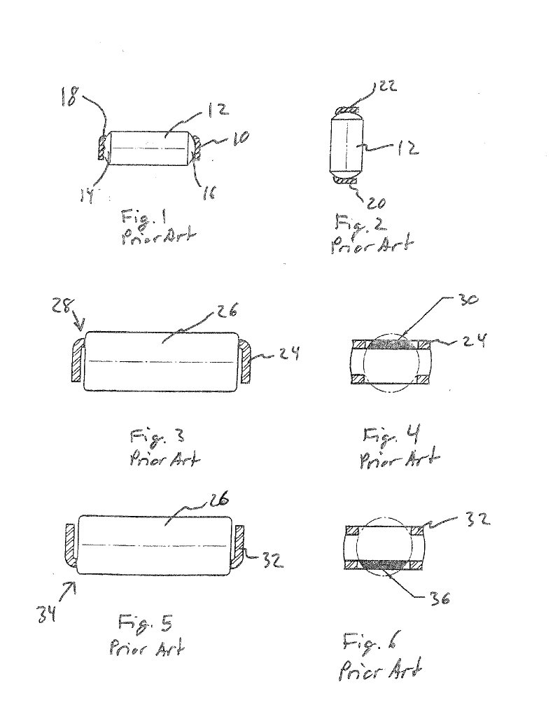

FIG. 2 shows a cross-sectional view of a known axial cage 20 with a domed end (NRA) style roller 12 used to reduce contact between the roller ends 14, 16 and the cage pocket 22.

FIG. 3 shows a cross-sectional view of a standard “M” cage 24 with a standard end roller 26 positioned in a cage pocket 28.

FIG. 4 shows an end view of the standard “M” cage 24 and the area where the roller 26 contacts a cage pocket end 30. This configuration provides minimal contact between the roller 26 and the cage pocket end 30.

FIG. 5 shows a cross-sectional view of a standard “W” or “U” cage 32 with a standard end roller 26 positioned in a cage pocket 34.

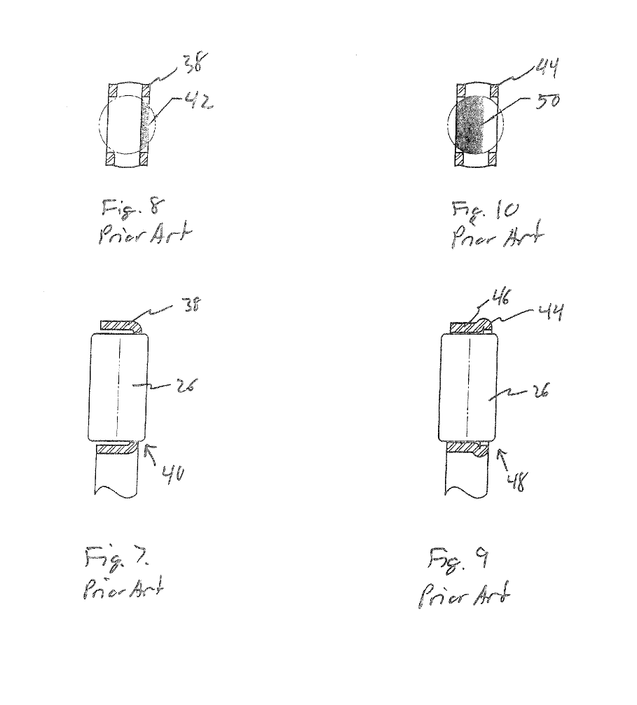

FIG. 6 shows an end view of the standard “W” or “U” cage 34 and the area where the roller 26 contacts a pocket end 36. Again, this configuration provides minimal contact between the roller 26 and the cage pocket end 36.

FIG. 7 shows a cross-sectional view of a standard “sigma” cage 38 with a standard end roller 26 positioned in a cage pocket 40.

FIG. 8 shows an end view of the standard sigma cage 38 and the area where the roller 26 contacts a pocket end 42. Similar to the M, W, or U cages 24, 26, 34, this configuration provides minimal contact between the roller 26 and the cage pocket end 42.

FIG. 9 shows a cross-sectional view of another sigma cage 44 with a standard end roller 26. The sigma style cage 44 has flanges 46 bent inward, toward the roller 26 to provide additional contact area between the pocket end 48 and the roller 26.

FIG. 10 shows an end view of the sigma cage 44 and the area where the roller 26 contacts a pocket end 50. As shown, the contact area where the roller 26 contacts the pocket end 50 is increased due to the design of the cage flanges 46 of the sigma style cage 44.

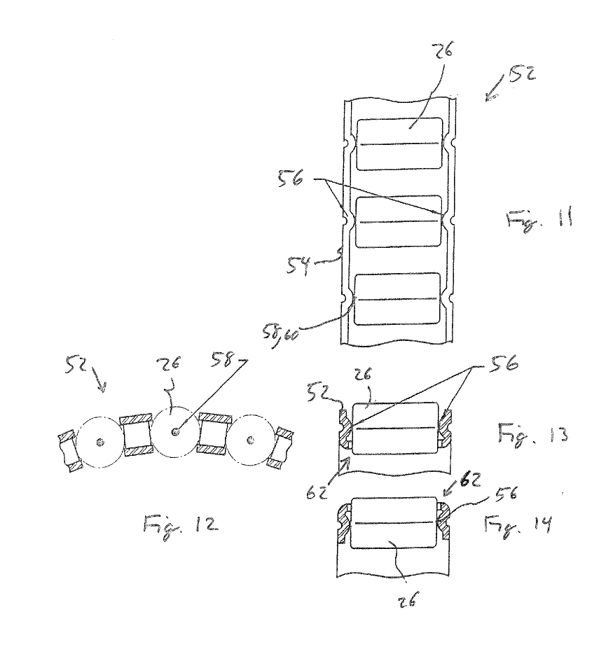

FIG. 11 shows a top view of a radial hearing cage 52 of the present invention with the high speed feature. The radial bearing cage flange 54 has dome-shaped protrusions 56 that contact the centers of a roller 26. The protrusions 56 reduce the surface contact area between the ends of the rollers 58 and the ends of the pockets 60. The protrusions 56 are the only part of the cage 54 that contacts the ends of the roller 58. The area of contact is small due to the domed shape of the protrusion 56. The points of contact are in the center of the rollers 26, thus reducing relative speed between the ends of the pockets 60 and the spinning rollers 26.

FIG. 12 is a cross-sectional view of the radial cage 52 and rollers 26. As shown, the minimal contact area between the rollers 26 and the protrusions 56 is in the center of the roller ends 58.

FIG. 13 shows a cross-sectional view of the radial bearing cage 52 and a roller 26 arranged in a pocket 62 between two protrusions 56 of the cage 52.

FIG. 14 is an inverted cross-sectional view of the radial roller bearing cage 52 having the special features shown in FIG. 13.

FIG. 15 shows a top view of a thrust bearing cage 64 of the present invention with the high speed feature. The cage flange 66 has dome-shaped protrusions 68 that contact the centers of a roller 26. The protrusions 68 reduce the surface contact area between the ends of the rollers 26 and the ends of the pockets 70. The protrusions 68 are the only part of the cage 64 that contacts the ends of the roller 26. The area of contact is small due to the domed shape of the protrusion 68. The points of contact are in the center of the rollers 26, thus reducing relative speed between the ends of the pockets 70 and the spinning rollers 26.

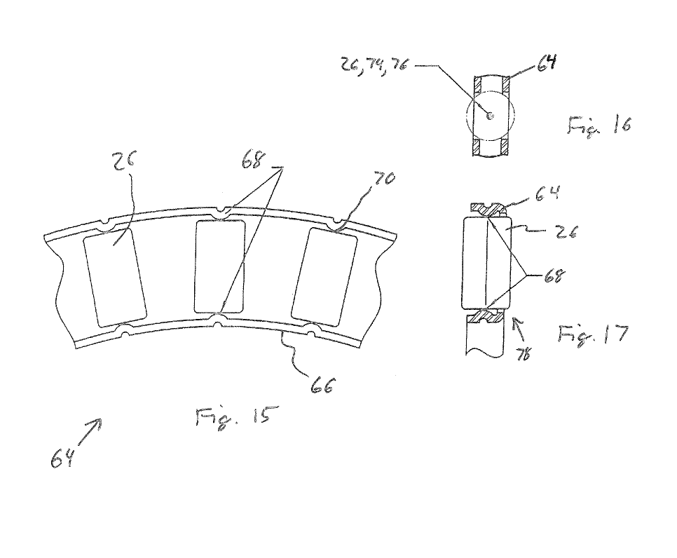

FIG. 16 shows an end view of the thrust bearing cage 64 and the minimal contact area between the rollers 26 and the protrusions 68, which is in the center 74 of the roller 26 ends 76.

FIG. 17 is a cross-sectional view of the thrust bearing cage 64 and a roller 26 arranged in a pocket 78 between two protrusions 68 of the cage 64.

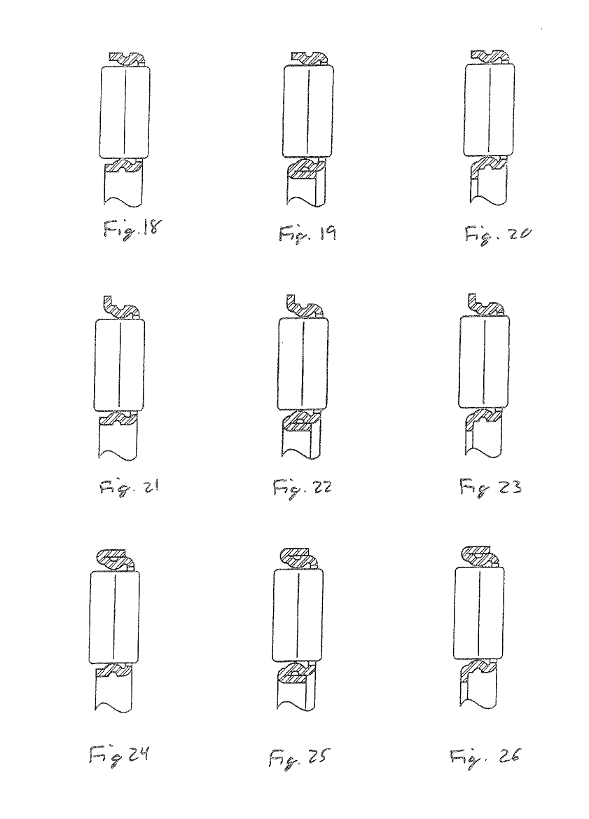

FIGS. 18-26 show various flange configurations for the radial bearing cage 52 or thrust bearing cage 64 of the present invention. Other flange configurations, not depicted, are also possible for use with the radial bearing cage 52 or thrust bearing cage 64 of the present invention.

The present invention has been described with reference to a preferred embodiment. It should be understood that the scope of the present invention is defined by the claims and is not intended to be limited to the specific embodiment disclosed herein.

What is claimed:

1. A bearing cage with high speed features, comprising:
a pocket having a first flange and a second flange defining outer boundaries of the pocket, the first flange and the second flange each having a plurality of inwardly directed protrusions facing each other.

2. The bearing cage of claim 1, wherein rollers are arranged in the cage.

3. The bearing cage of claim 2, wherein the protrusions are contactable with the rollers.

4. The bearing cage of claim 3, wherein the protrusions and rollers are contactable at a center of ends of the rollers.

5. The bearing cage of claim 1, wherein the protrusions are dome shaped.

6. The bearing cage of claim 1, wherein bearing cage is a radial bearing cage.

7. The hearing cage of claim 1, wherein the bearing cage is a thrust bearing cage.
